(19) United States
(12) Patent Application Publication
(10) Pub. No.: US 2008/0267393 A1
(43) Pub. Date: Oct. 30, 2008

(54) AES DECRYPTION APPARATUS AND PROGRAM

(76) Inventor: Fumihiko SANO, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/034,994

(22) Filed: Feb. 21, 2008

(30) Foreign Application Priority Data
Feb. 23, 2007 (JP) 2007-044121

(51) Int. Cl. H04L 9/28

(52) U.S. Cl. 380/28

(57) ABSTRACT

When a matrix operation based on the specifications of inverse mixcolumn transformation InvMixColumns( ) of AES decryption is executed by the product of a first matrix Pb and a second matrix Pa, 16 coefficients pb₁₁, . . . , pb₄₄ of the first matrix Pb are composed of {1}, {4} and {5} only, and 16 coefficients pa₁₁, . . . , pa₄₄ of the second matrix Pa are composed of {0}, {2} and {3} only. Therefore, compared with prior art, through a necessary memory capacity is the same, the number of additions can be decreased by two.

### CROSS-REFERENCE TO RELATED APPLICATIONS

This application is based upon and claims the benefit of priority from prior Japanese Patent Application No. 2007-044121, filed Feb. 23, 2007, the entire contents of which are incorporated herein by reference.

### BACKGROUND OF THE INVENTION

1. Field of the Invention

The present invention relates to an AES decryption apparatus and program used for AES cryptography, and more particularly an AES decryption apparatus and program capable of decreasing the number of operations while preventing an increase in the capacity of a necessary memory.

2. Description of the Related Art

Cryptographic technology is effective to conceal or authenticate data, and widely used. There are two methods of cryptography, symmetric-key cryptography and public-key cryptography. In the symmetric-key cryptography, the same symmetric key is used in both encryption side and decryption side. A symmetric key is kept in secret, and used to decrypt or authenticate encrypted data (hereinafter, called ciphertext). In public-key cryptography, a different key is used in encryption side and decryption side. A key used to decrypt ciphertext is kept in secrete, and a key used to encrypt ciphertext is open to the public.

To establish speedy and safety symmetric-key cryptography, data to be encrypted is divided into appropriate-length blocks, and each block is encrypted. This method is called block cryptography. As typical block cryptography, Data Encryption Standard (DES) cryptography is well known.

Symmetric-key cryptography including DES cryptography consists of combination of substitution and permutation. Substitution and permutation are usual concepts of symmetric-key cryptography. In DES cryptography, eight kinds of reference table are used for substitution, and a 6-bit input is converted to 4 bits. The substitution using these reference tables is generally called an S-box. There is P-transposition as a typical permutation in DES cryptography. The P-permutation permutes 32-bit input data to obtain 32-bit output data.

As a typical example of block cryptography similar to DES cryptography, AES cryptography is well known (e.g., National Institute of Standards and Technology: Refer to “Advanced Encryption Standard”, Federal Information Processing Standards 197, 2001). In AES cryptography, 8-bit input data is converted to 8-bit output data by using only one kind of reference table. Basic transposition is expressed by multiplication on a Galois field. This transposition is called a mixcolumn operation (MixColumns( )). In AES cryptography, a cryptograph called (RIJNDAEL) is mounted under predetermined parameters.

AES cryptography has stages of substitution permutation network (SPN) pattern structure. A first stage of SPN pattern structure can be expressed by a matrix operation as indicated by the following equation (1).

$$[ \begin{matrix}{y}_{1} \\ {y}_{2} \\ ⋮ \\ {y}_{n}\end{matrix} ] = [ \begin{matrix}{p}_{11} & {p}_{12} & … & {p}_{1 n} \\ {p}_{21} & {p}_{22} & … & {p}_{2 n} \\ ⋮ & ⋮ & … & ⋮ \\ {p}_{n 1} & {p}_{n 2} & … & {p}_{nn}\end{matrix} ] [ \begin{matrix}s ( {x}_{1} , {k}_{1} ) \\ s ( {x}_{2} , {k}_{2} ) \\ ⋮ \\ s ( {x}_{n} , {k}_{n} )\end{matrix} ] \qquad ( 1 )$$

Here, S(x, k) is an output of substitution for combination of an input x and a key k. The term pij (i=1, . . . , n; j=1, . . . , n) is a matrix P indicating transposition. Hereinafter, the key k will be omitted and expressed as S(x) to simplify the expression without losing generality. Namely, “x” is a intermediate value obtained by computation of an input and a key.

In AES cryptography, calculation of mixcolumns (Mixcolumns( )) to perform transposition for each j-column of an input array with 4 rows×4 columns Xᵢⱼ (i, j=1, 2, 3, 4) is defined by the following matrix operation.

$$[ \begin{matrix}{y}_{1 j} \\ {y}_{2 j} \\ {y}_{3 j} \\ {y}_{4 j}\end{matrix} ] = [ \begin{matrix}2 & 3 & 1 & 1 \\ 1 & 2 & 3 & 1 \\ 1 & 1 & 2 & 3 \\ 3 & 1 & 1 & 2\end{matrix} ] [ \begin{matrix}s ( {x}_{1 j} ) \\ s ( {x}_{2 j} ) \\ s ( {x}_{3 j} ) \\ s ( {x}_{4 j} )\end{matrix} ] \qquad ( 2 )$$

Here, an element (or a coefficient) of the matrix P has 16 kinds of pattern, O-times, 1-times, x-times, . . . , +x̂3+x̂2+1 (the symbol ̂ indicates a power). AES cryptography uses multiplication on a so-called Galois field and an irreducible polynomial (x̂4+x+1). Namely, when the result of multiplication is greater than x̂4, a remainder of (x̂4+x+1) is used.

In the specifications of AES cryptography, when mixcolumns processing is expressed by a matrix operation, the above coefficient expanded in a binary scale is expressed in a hexadecimal scale to simplify the expression. Specifically, x-times can be described as 0010 by a 4-digit decimal number, and described as a coefficient {2} by a hexadecimal number. Similarly, a coefficient {1} of an element of the matrix P corresponds to 1-times, 2 corresponds to x-times, and 3 corresponds to (x+1) times. An addition in a matrix operation corresponds to a calculation of exclusive OR (or XOR).

In a simplest method of mounting AES cryptography, the result of substitution by S-box is calculated for each of four inputs x₁ⱼ, . . . , x₄ⱼ, and the result of substitution of each of x₁ⱼ, x₂ⱼ, x₃ⱼ and x₄ⱼ is multiplied by x-times, (x+1) times, 1-times and 1-times, and added to each of them if the calculation is for y₁ⱼ. Assuming that an advance calculation reference table is used for all multiplications on the Galois field used for calculation of a determinant, a required memory capacity corresponds to the result of one kind of substitution S and two kinds of multiplications.

Expressing x-times calculations as xtime( ), the procedure of the calculation of the equation (2) is expressed as shown in FIG. 1. Namely, the inputs x₁ⱼ-x₄ⱼ are substituted by S-box to obtain the results of the substitution t₁-t₄ (ST1). The results of substitution t₁-t₄ are multiplied by the first and third rows of the matrix P to obtain the results y₁ⱼ and y₃ⱼ (ST2). At the same time, the results of substitution t₁-t₄ are multiplied by the second and fourth rows of the matrix P to obtain the results y₂ⱼ and y₄ⱼ (ST3).

Calculation of the encryption equation (2) requires a memory capacity, the number of references to a reference table and number of additions, such as, a memory capacity necessary for 1-unit substitution (a memory capacity of a reference table [S-box] for substitution), a memory capacity necessary for 1-unit permutation (a memory capacity of a reference table for permutation (results of more than x-times advance calculations), references to a reference table for 4 substitutions (the number of “S( )”), references to a reference table for more than 4-times operations for 4 substitutions (the number of “xtime( )”), and additions for 8 substitutions (the number of “+”), for each one line, as shown in FIG. 2.

Hereinafter, x-times operations will be explained as reference to a reference table (the results of x-times advance calculations), instead of calculating the remainder by bit shift and irreducible polynomial (x̂4+x+1). Reference to a reference table corresponds to execution of x-times calculations at each time, in other words.

As the S-box is 8-bit input/8-bit output, a 1-unit memory capacity becomes 256 bytes in general, here in AES cryptography. The number of calculations is the number of calculations of 8 bits and 8 bits.

The above mounting method is a simplest example. If a necessary memory capacity and operation word length are sufficient, a mounting method becomes more efficient. For example, necessary calculation amount can be reduced by previously calculating the output of a substitution-permutation SP combining substitution by an S-box and permutation by a matrix P, in a memory.

As an example of an efficient mounting method, there is a case using a 32-bit advance calculation reference table, in which an 8-bit output of substitution S executed for 8-bit input x₁ⱼ, . . . , x₄ⱼ is multiplied by x-times, (x+1) times, 1-times, and 1-times, respectively. In this case, calculation of the encryption equation (2) requires a memory capacity, number of references to a reference table, number of shifts and number of additions, such as, a memory capacity necessary for 4-unit substitution-permutation, references to a reference table for 4 substitutions/transformations, shifts for 3 substitutions/transformations, and additions for 3 substitutions/transformations, for each line.

Comparing with the simplest mounting method, this efficient mounting method can decrease the number of operations while increasing a memory capacity, and can increase the processing efficiency by decreasing the number of references to a reference table, which is especially low speed among operations of a computer.

However, as a computer needs to have a 4-byte operation word length in this efficient mounting method, if a computer has a 2-byte operation word length, the number of all operations is increased double, and the processing efficiency is not much increased.

The above is a typical mounting method of encryption in AES cryptography.

However, as encryption procedure is a little different from a decryption procedure in AES cryptography, a memory is necessary to store advance calculations for substitution or substitution-permutation separately from encryption.

Decryption in AES cryptography needs inverse mixcolumn transformation (InvMixcolumn) as an operation of inverse transposition to erase transposition in the mixcolumn processing executed upon encryption. Inverse mixcolumn transformation is defined by a matrix operation indicated by the following equation (3), for each j-column of an input array yᵢⱼ with 4 rows×4 columns (i, j=1, 2, 3, 4). Here, “E” is a hexadecimal scale, and corresponds to (x̂3+x̂2+x) times.

$$[ \begin{matrix}{x}_{1 j} \\ {x}_{2 j} \\ {x}_{3 j} \\ {x}_{4 j}\end{matrix} ] = [ \begin{matrix}E & B & D & 9 \\ 9 & E & B & D \\ D & 9 & E & B \\ B & D & 9 & E\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ] \qquad ( 3 )$$

In a simplest method of mounting decryption in AES cryptography, the result of inverse transformation by S-box is calculated for each of four inputs x₁ⱼ, . . . , x₄ⱼ, and the result of substitution of each of x₁ⱼ, x₂ⱼ, x₃ⱼ, and x₄ⱼ is multiplied by (x̂3+x̂2+x) times, (x̂3+x+1) times, (x̂3+x̂2+1) times and (x̂3+1) times, and added for each of them, if the calculation is for y₁ⱼ. Assuming that an advance calculation reference table is used for all multiplications of higher than x-times on the Galois field used for calculation of a determinant, a required memory capacity corresponds to the result of one kind of substitution s′ and four kinds of multiplication.

Calculation of the decryption equation (3) requires a memory capacity, number of references to a reference table and number of additions, such as, a memory capacity necessary for 1-unit substitution, a memory capacity necessary for 4-unit permutation, references to a reference table for 4 substitutions, references to a reference table for more than x-times operations for 16 substitutions, and additions for 12 substitutions, for each one line, as shown in FIG. 2.

Therefore, AES decryption requires a memory capacity and the number of references more than those in the AES encryption.

The above mounting method is a simplest example. if a necessary memory capacity and operation word length are sufficient, a mounting method becomes more efficient. For example, necessary calculation amount can be reduced by previously calculating the output of a substitution-permutation of a substitution-permutation S′P′ combining inverse transformation S′ by S-box and inverse transformation P′ by matrix P, in a memory.

As an example of an efficient mounting method, there is a case using a 32-bit advance calculation reference table, in which an 8-bit output of inverse transformation S′ of substitution executed for 8-bit inputs y₁ⱼ, . . . , y₄ⱼ is multiplied by (x̂3+x̂2+1) times, (x̂3+x+1), (x̂3++x̂2+1), and (x̂3+1), respectively. In this case, calculation of the decryption equation (3) requires a memory capacity, the number of references to a reference table, the number of shifts and number of additions, such as, a memory capacity necessary for 16-unit substitution/permutation, references to a reference table for 4 substitutions/transformations, shifts for 3 substitutions/transformations, and additions for 3 substitutions/transformations, for each line.

Comparing with the simplest mounting method, this efficient mounting method can decrease the number of operations while increasing the memory capacity, and can increase the processing efficiency by decreasing the number of references to a reference table, which is especially low speed among operations of a computer.

In this efficient mounting method, unlike a simple mounting method in which the volume of operation in decryption is larger than encryption, the calculation amount is the same in encryption and decryption, and encryption and decryption except a key schedule can be executed with the same processing efficiency.

The above encryption and decryption in AES cryptography are efficient mounting methods in personal computer environment ensuring a necessary memory capacity. Namely, AES cryptography requires a different mounting method when it is used in a system, in which decrease in a necessary memory capacity is given a high priority. If a word length of a computer is small, a method of using a reference table of advance calculations decreases the processing efficiency.

On the other hand, in SHARK cryptography using multiplication on a Galois field for substitution, like AES cryptography, a method of decreasing an advance calculation reference table is disclosed, in addition to a method of using more than 32-bit output advance calculation reference table (e.g., Rijmen, et al. “The Cipher SHARK”, Fast Software Encryption, LNCS 1039, pp. 99-111, Springer-Verlag, 1996). This literature discloses a method of increasing the processing efficiency by decreasing the calculation amount by LU decomposition that is a basic matrix calculation method for performing a permutation matrix P.

Further, in Hierocrypt cipher using multiplication on a Galois field for substitution, like AES cryptography, the inventor discloses an efficient mounting method for a case that a computer word length is shorter than the operation width of permutation P (e.g., Sano, et al. “Hierocrypt Mounting”, Cryptography and Information Security Symposium, 2001). In this method, a permutation matrix P of SPN type cipher expressed by the equation (1) is calculated by using the product of two or more determinants. The following equation (4) indicates the permutation matrix P by the products of two matrixes Pa and Pb.

$$[ \begin{matrix}{y}_{1} \\ {y}_{2} \\ ⋮ \\ {y}_{n}\end{matrix} ] = [ \begin{matrix}{pa}_{11} & {pa}_{12} & … & {pa}_{1 n} \\ {pa}_{21} & {pa}_{22} & … & {pa}_{2 n} \\ ⋮ & ⋮ & … & ⋮ \\ {pa}_{n 1} & {pa}_{n 2} & … & {pa}_{nn}\end{matrix} ] [ \begin{matrix}{pb}_{11} & {pb}_{12} & … & {pb}_{1 n} \\ {pb}_{21} & {pb}_{22} & … & {pb}_{2 n} \\ ⋮ & ⋮ & … & ⋮ \\ {pb}_{n 1} & {pb}_{n 2} & … & {pb}_{nn}\end{matrix} ] [ \begin{matrix}s ( {x}_{1} ) \\ s ( {x}_{2} ) \\ ⋮ \\ s ( {x}_{n} )\end{matrix} ] \qquad ( 4 )$$

In this method, by selecting the matrixes pa and pb, a pair of x-times and x̂2 times operations can be realized by referring to one kind of operation reference table of x-times calculations by two times, not by referring to two kinds of operation reference table. Namely, the number of necessary advance calculation reference tables can be reduced. Selection of matrix depends on encryption algorithm, and not obvious.

In an encryption process of AES cryptography, as only two kinds of multiplication values, such as x-times and (x+1) times, appear in the permutation matrix P, and (x+1) times calculation of an input x can be calculated by adding the input x to the x-times calculations of the input x, it is possible to realize encryption by one kind of advance calculation reference table. Therefore, in the method using products of two or more matrixes indicated by the equation (4), the number of advance calculation reference tables cannot be reduced.

However, considering a decryption process of AES cryptography, decryption needs four kinds of advance calculation reference table, (x̂3+x̂2+x), (x̂3+x+1), (x̂3+x̂2+1), and (x̂3+1) times. Here, the number of advance calculation reference tables can be reduced by expressing the inverse matrix P′ of permutation matrix by products of two or more matrixes. Reduction of the number of advance calculation reference tables is useful when using a system with high priority given to decrease of necessary memory, such as an IC card and controller.

Paulo Barreto applies a similar idea to decryption in AES cryptography, and proposes a method of calculating an inverse transformation P′ of permutation P by the matrix operation indicated by the following equation (5) (e.g., Public Comments on the Draft Federal Information Processing Standard [FIPS] for the Advanced Encryption Standard [AES]).

$$[ \begin{matrix}{x}_{1 j} \\ {x}_{2 j} \\ {x}_{3 j} \\ {x}_{4 j}\end{matrix} ] = [ \begin{matrix}5 & 0 & 4 & 0 \\ 0 & 5 & 0 & 4 \\ 4 & 0 & 5 & 0 \\ 0 & 4 & 0 & 5\end{matrix} ] [ \begin{matrix}2 & 3 & 1 & 1 \\ 1 & 2 & 3 & 1 \\ 1 & 1 & 2 & 3 \\ 3 & 1 & 1 & 2\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ] \qquad ( 5 )$$

Expressing x-times calculations as xtime( ), the calculation procedure of the equation (5) is as shown in FIG. 3. Namely, the inputs y₁ⱼ-y₄ⱼ of the j-column of the input array yᵢⱼ (i, j=1, 2, 3, 4) with 4 rows×4 columns are substituted by using S-box to obtain the results of substitution t₁-t₄ (ST11).

Then, obtain the results of substitution t₁-t₄ and the results of multiplication still in progress v₁ and v₃ of first row (2311) and third row (1123) of the first matrix (ST12), and at the same time, obtain the results of substitution t₁-t₄ and the results of multiplication still in progress v₂ and v₄ of the first row (1231) and fourth row (3112) of the first matrix (ST13). Further, add the results of substitution t₁-t₄ to the results of multiplication still in progress v₁-v₄, and obtain the results of multiplication v₁-v₄ (ST14). The results of multiplication v₁-v₄ mean the results of multiplication of the results of substitution t₁-t₄ and first matrix.

Then, execute multiplication of the results of multiplication v₁-v₄ and second matrix. Specifically, execute x-times calculations for the results of multiplication v₁-v₄, and calculate the results still in progress w₁ and w₂ (ST15). Add the results of multiplication v₁-v₄ to the results still in progress w₁ and w₂, and calculate the results of multiplication x₁ⱼ-x₄ⱼ (ST16). The results of multiplication x₁ⱼ-x₄ⱼ mean the results of multiplication of the results of multiplication v₁-v₄ and second matrix, in other words, the result P′ of inverse mixcolumn transformation for the inputs y₁ⱼ-₄ⱼ of the j-column.

The method of Paulo Barreto is a method of realizing inverse mixcolumn transformation (InvMixColumn) of permutation P′ of decryption by adding least additional operation, based on mixcolumn processing (MixColumn) of permutation P of encryption.

Specifically, the inverse transformation P′ for decryption adds 10 additions (XOR operation) and 4 times of x-times calculations to the permutation P of encryption, and requires a memory capacity, the number of references to a reference table and number of additions, such as, a memory capacity necessary for 1-unit substitution (a memory capacity of a substitution reference table [S-box]), a memory capacity necessary for 1-unit permutation (a memory capacity of a permutation reference table [results of advance calculations of more than x-times operations]), the number of references to a reference table for 8 substitutions of more than x-times operations (the number of “xtime( )”), and additions for 18 substitutions (number of “+”), for each one line, as shown in FIG. 4.

The method of Paulo Barreto is excellent in the point that encryption and decryption can share a part of processing. As a shared part is small, compared with the mounting in software, this method is suitable for mounting in hardware to reduce the scale of circuit as far as possible.

However, according to the examination by the inventor, the method of Paulo Barreto is excellent from the viewpoint of decreasing a memory capacity, but as it includes permutation P for encryption, this method is not necessarily optimum as a mounting method. Namely, the method of Paulo Barreto is considered to have a room to decrease the number of operations, while preventing increase in a necessary memory capacity, for example.

### BRIEF SUMMARY OF THE INVENTION

It is an object of the invention to provide an AES decryption apparatus and program, which can decrease the number of operations, while preventing increase in a necessary memory capacity.

According to a first aspect of the present invention, there is provided an AES decryption apparatus of AES cryptography including byte substitution inverse transformation InvSubBytes( ) and inverse mixcolumn transformation InvMixColumns( ), comprising: an inverse S-box storage device which is used for the byte substitution inverse transformation InvSubBytes( ), and stores S-box information that previously associates row and column data of half bits of substitution object data with a result of byte substitution inverse transformation s′( ); a byte substitution inverse transformation device configured to execute the byte substitution inverse transformation InvSubBytes( ), to obtain a result of byte substitution inverse transformation s′(yᵢⱼ) while referring to the inverse S-box information, based on input data yᵢⱼ (i, j=1, 2, 3, 4) with 4 rows and 4 columns as the substitution object data; a byte substitution inverse transformation result storage device which stores the result of byte substitution inverse transformation s′(yᵢⱼ) obtained by the byte substitution inverse transformation device; an inverse mixcolumn transformation device configured to execute the inverse mixcolumn transformation InvMixColumns( ), to obtain results of inverse mixcolumn transformation (x₁ⱼ, x₂ⱼ, . . . , x₄ⱼ), by multiplying results of byte substitution inverse transformation for each column (s′(y₁ⱼ), s′(y₂ⱼ), . . . , s′(y₄ⱼ)) by a first matrix Pb=(pbᵢⱼ) (i, j=1, 2, 3, 4) and second matrix Pa=(paᵢⱼ) (i, j=1, 2, 3, 4), based on the result of byte substitution inverse transformation s′(yᵢⱼ) in the byte substitution inverse transformation result storage device, as indicated by the equation

$$[ \begin{matrix}{x}_{1 j} \\ {x}_{2 j} \\ {x}_{3 j} \\ {x}_{4 j}\end{matrix} ] = [ \begin{matrix}{pa}_{11} & {pa}_{12} & … & {pa}_{14} \\ {pa}_{21} & {pa}_{22} & … & {pa}_{24} \\ {pa}_{31} & {pa}_{32} & … & {pa}_{34} \\ {pa}_{41} & {pa}_{42} & … & {pa}_{44}\end{matrix} ] [ \begin{matrix}{pb}_{11} & {pb}_{12} & … & {pb}_{14} \\ {pb}_{21} & {pb}_{22} & … & {pb}_{24} \\ {pb}_{31} & {pb}_{32} & … & {pb}_{34} \\ {pb}_{41} & {pb}_{42} & … & {pb}_{44}\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ]$$

wherein 16 coefficients pb₁₁, . . . , pb₄₄ of the first matrix Pb consist of {1}, {4} and {5} only, and 16 coefficients pa₁₁, . . . , pa₄₄ of the second matrix Pa consist of {0}, {2} and {3} only.

The first aspect is expressed as an “apparatus”, but not to be limited to an apparatus. The aspect may be expressed as a “method” or a “storage medium storing a program”.

According to the first aspect, 16 coefficients pb₁₁, . . . , pb₄₄ of a first matrix Pb are composed of {1}, {4} and {5} only, and 16 coefficients pa₁₁, . . . , pa₄₄ of a second matrix Pa are composed of {0}, {2} and {3} only, and as seen from conventional embodiments shown in FIG. 4 and FIG. 9, even if a necessary memory capacity is the same, the number of additions can be decreased by 2. Namely, in the first aspect, the number of operations can be decreased while preventing increase in a necessary memory capacity.

### BRIEF DESCRIPTION OF THE SEVERAL VIEWS OF THE DRAWING

FIG. 1 is a flowchart for explaining mixcolumn transformation in general encryption in detail;

FIG. 2 is a table showing a memory capacity and the number of operations necessary for mixcolumn transformation in general encryption;

FIG. 3 is a flowchart for explaining conventional inverse mixcolumn transformation in detail;

FIG. 4 is a table showing a memory capacity and the number of operations necessary for conventional mixcolumn transformation;

FIG. 5 is a schematic diagram showing the configuration of a computer adopting an AES decryption apparatus in a first embodiment of the invention;

FIG. 6 is a flowchart for explaining decryption of AES cryptograph in the same embodiment;

FIG. 7 is a flowchart for explaining inverse mixcolumn transformation in the same embodiment;

FIG. 8 is a flowchart for explaining inverse mixcolumn transformation in the same embodiment in detail;

FIG. 9 is a table showing a memory capacity and the number of operations necessary for inverse mixcolumn transformation in the same embodiment;

FIG. 10 is a flowchart for explaining inverse mixcolumn transformation in a second embodiment; and

FIG. 11 is a flowchart for explaining inverse mixcolumn transformation in the same embodiment in detail.

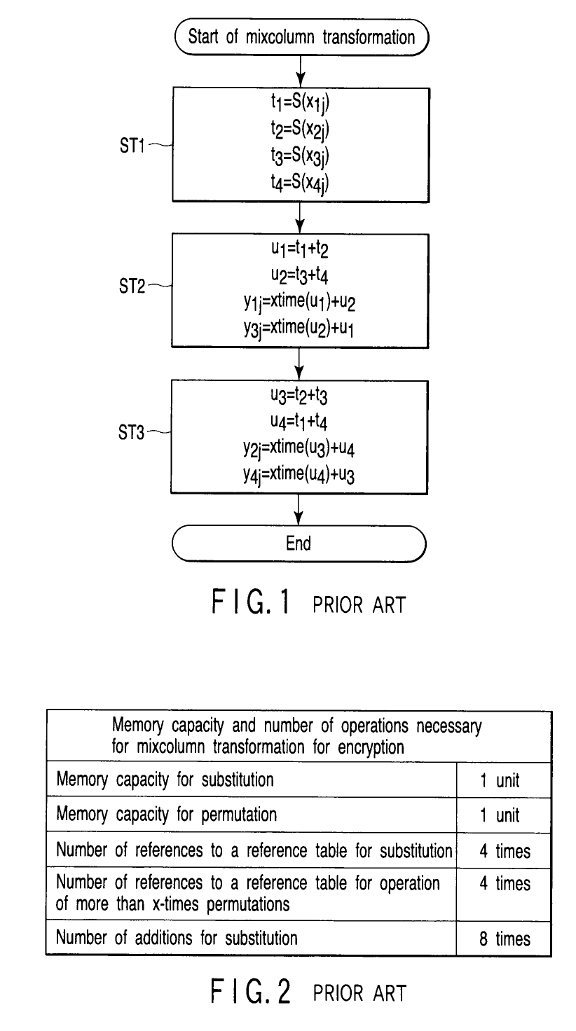

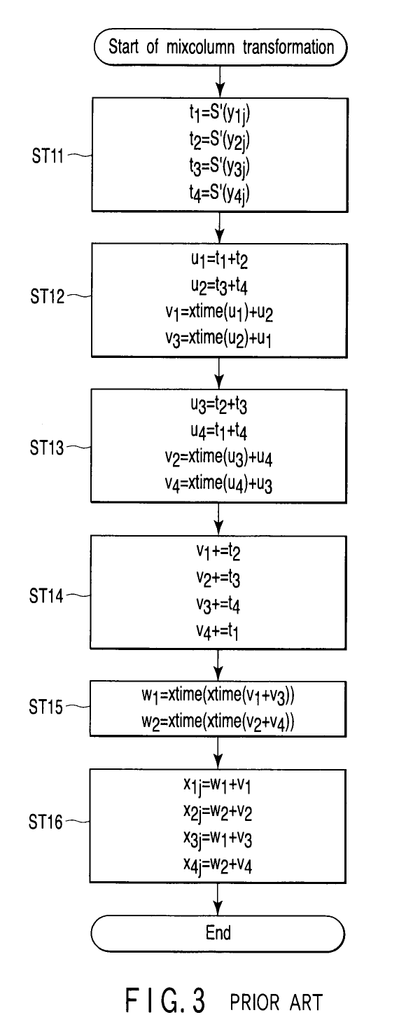

### DETAILED DESCRIPTION OF THE INVENTION

Hereinafter, embodiments of the invention will be explained by using the accompanied drawings. An AES decryption apparatus described hereinafter can be embodied in any one of hardware and combination of hardware resources and software. As software for the combination with hardware resources, a program, which is previously installed in a computer of an AES decryption apparatus from network or a storage medium M, and realizes the function of an AES encryption apparatus in the computer, is used.

### Embodiment 1

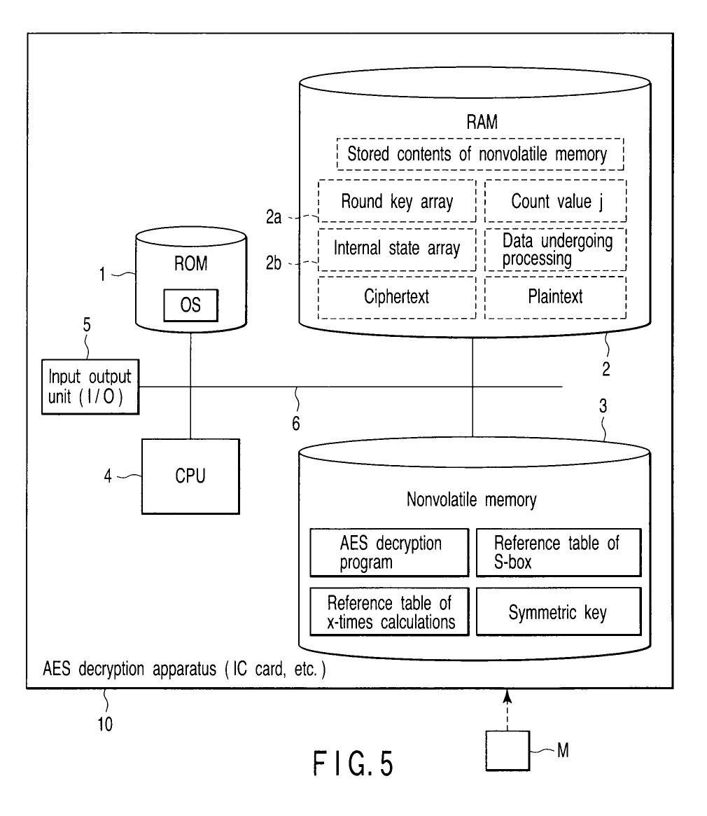

FIG. 5 is a schematic diagram showing the configuration of an AES decryption apparatus according to a first embodiment of the invention. An AES decryption apparatus 10 is an apparatus based on an AES cryptography including inverse byte substitution transformation InvSubBytes ( ) and inverse mixcolumn transformation InvMixColumns ( ).

Specifically, the AES decryption apparatus 10 is an apparatus required to decrease a necessary memory capacity, such as an IC card or controller, and is configured such that a ROM 1, a RAM 2, a nonvolatile memory 3, a CPU 4 and an input/output unit 5 are connected through a bus 6.

Here, the ROM 1 is a read-only memory readable from the CPU 5, and previously stores an OS of the AES decryption apparatus 10.

The RAM 2 is a random access memory readable/writable from the CPU 5, which is used to read the contents of the nonvolatile memory 3, and to temporarily store ciphertext, a key, data undergoing processing, decoded plaintext, etc., during AES decryption. A round key array 2a and an internal sate array (Stage array) 2b are formed in an area of the RAM 2.

The nonvolatile memory 3 is a memory readable/writable from the CPU 5, and the stored contents are not erased even if the power is turned off. For example, the nonvolatile memory previously stores an AES decryption program installed from an external storage medium, a reference table (inverse S-box information) corresponding to an inverse S-box, and a reference table (multiplication table data) indicating the result of x-times advance calculations, and appropriately stores a key shared by an external AES encryption apparatus (not shown), etc. The length of a shared key (a symmetric key) may be any one of 128 bits, 192 bits and 256 bits, as defined in the specifications of AES cryptography.

One reference table (inverse S-box information) corresponds to an 8-bit input/8-bit output, and is used for byte substitution inverse transformation InvSubBytes ( ), in which row/column data of half bits of substitution object data is previously associated with the result of byte substitution inverse transformation s′( ). Here, the input data yᵢⱼ comprising i-row and j-column as substitution object data is individually associated with the result of byte substitution inverse transformation s′(yᵢⱼ). For example, the reference table is configured as a substitution table, which associates the input data y₁₂={ed} with the result of byte substitution inverse transformation s′(ed)={53} in the d-column of the e-row.

The other reference table (multiplication table data) corresponds to an 8-bit input/8-bit output, and is referred to during a matrix operation, and indicates the result of multiplication of the coefficient {2} by a multiplier.

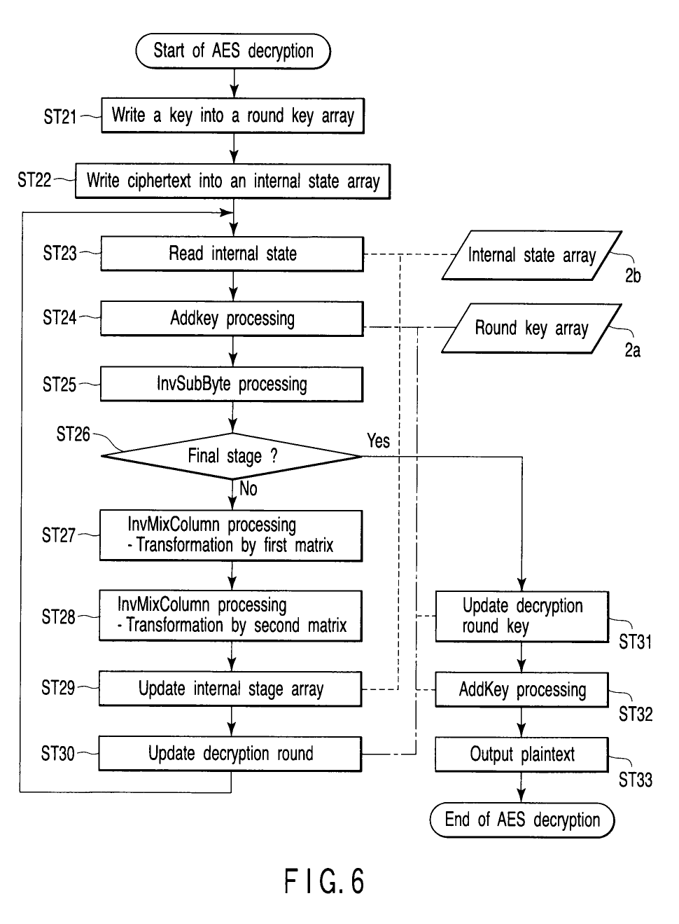

The CPU 4 executes AES decryption of encrypted data input from the input/output unit 5, and outputs the decryption result from the input/output unit 5. Specifically, the CPU 4 has a function of executing the processing shown in FIG. 6-FIG. 8, while referring to the memories 1-3.

The CPU 4 has the following functions (f4-1)-(f4-3).

(f4-1) Function to obtain the result of byte substitution reverse transformation s′(yᵢⱼ) by executing byte substitution inverse transformation InvSubBytes ( ) while referring to a reference table corresponding to an inverse S-box, based on the input data yᵢⱼ (i, j=1, 2, 3, 4) with i-row and j-column.

(f4-2) Function to write the obtained result of byte substitution inverse transformation s′(yᵢⱼ) into the RAM 2.

(f4-3) Function to obtain the result of (x₁ⱼ, x₂ⱼ, . . . , x₄ⱼ) by executing byte substitution inverse transformation InvMixcolumns( ), by multiplying the result of byte substitution inverse transformation (s′(y₁ⱼ), (y₂ⱼ), . . . , s′(y₄ⱼ)) for each j-column by the first matrix Pb=(pbᵢⱼ) (i, j=1, 2, 3, 4) and second matrix Pa=(paᵢⱼ) (i, j=1, 2, 3, 4), based on the result of byte substitution inverse transformation s′(yᵢⱼ).

$$[ \begin{matrix}{x}_{1 j} \\ {x}_{2 j} \\ {x}_{3 j} \\ {x}_{4 j}\end{matrix} ] = [ \begin{matrix}{pa}_{11} & {pa}_{12} & … & {pa}_{14} \\ {pa}_{21} & {pa}_{22} & … & {pa}_{24} \\ {pa}_{31} & {pa}_{32} & … & {pa}_{34} \\ {pa}_{41} & {pa}_{42} & … & {pa}_{44}\end{matrix} ] [ \begin{matrix}{pb}_{11} & {pb}_{12} & … & {pb}_{14} \\ {pb}_{21} & {pb}_{22} & … & {pb}_{24} \\ {pb}_{31} & {pb}_{32} & … & {pb}_{34} \\ {pb}_{41} & {pb}_{42} & … & {pb}_{44}\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ]$$

Sixteen coefficients pb₁₁, . . . , pb₄₄ of the first matrix Pb consist of {1}, {4} and {5} only. Sixteen coefficients pa₁₁, . . . , p₄₄ of the second matrix Pa consist of {0}, {2} and {3} only.

The first matrix Pb and second matrix Pa used in this embodiment are as follows.

$$Pb = [ \begin{matrix}1 & 4 & 1 & 5 \\ 5 & 1 & 4 & 1 \\ 1 & 5 & 1 & 4 \\ 4 & 1 & 5 & 1\end{matrix} ]$$

$$P a = [ \begin{matrix}2 & 0 & 0 & 3 \\ 3 & 2 & 0 & 0 \\ 0 & 3 & 2 & 0 \\ 0 & 0 & 3 & 2\end{matrix} ]$$

Therefore, the inverse mixcolumn transformation InvMixColumns ( ) is expressed by a matrix operation of the following equation (6).

$$[ \begin{matrix}{x}_{1 j} \\ {x}_{2 j} \\ {x}_{3 j} \\ {x}_{4 j}\end{matrix} ] = [ \begin{matrix}2 & 0 & 0 & 3 \\ 3 & 2 & 0 & 0 \\ 0 & 3 & 2 & 0 \\ 0 & 0 & 3 & 2\end{matrix} ] [ \begin{matrix}1 & 4 & 1 & 5 \\ 5 & 1 & 4 & 1 \\ 1 & 5 & 1 & 4 \\ 4 & 1 & 5 & 1\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ] \qquad ( 6 )$$

The CPU 4 may execute multiplication by using a first matrix Pb′ where one or both of i-row and j-column in the first matrix Pb is replaced, instead of the first matrix Pb, and a second matrix Pa′ where one or both of i-row and j-column in the second matrix Pb is replaced, instead of the second matrix Pa. An example of this replacement will be specifically described in a second embodiment.

Further, during multiplication, the CPU 4 executes multiplication of the coefficients {4} and {5} in the first matrix Pb by 2 multiplications of the coefficient {2} and addition, and executes multiplication of the coefficients {2} and {3} in the second matrix Pa by 1-times multiplication of the coefficient {2} and addition. Multiplication of the coefficient {2} is executed by referring to the reference table (multiplication table data) in the RAM 2.

The input/output unit 5 has a function to input/output data between a not-shown external unit and the AES decryption apparatus 10. If the AES decryption apparatus 10 is an IC card, the input/output unit has a function to supply power to the AES decryption apparatus 10 from an external power supply.

Next, an explanation will be given on the operation of the AES decryption apparatus configured as described above by using the flowchart of FIG. 6-FIG. 8.

(Decryption of AES Cryptograph)

It is assumed that an AES decryption program is started by an operator in the AES decryption apparatus 10, and the contents of the nonvolatile memory 3 are written into the RAM 2. It is also assumed that a decryption request is entered through the input/output unit 5 in the AES decryption apparatus, after encrypted data is written into the RAM 2 by an operator through the input/output unit 5.

Receiving the decryption request, the CPU 4 writes a key in the RAM 2 into the round key array 2a (ST21), and writes the encrypted data into the internal state array 2b in the RAM 2 (ST22).

Thereafter, the CPU 4 repeatedly executes decryption based on the specifications of AES cryptography (ST22-ST30). In AES cryptography, decryption is repeated by 10 times when a 128-bit key is used, 12 times when a 192-bit key is used, and 14 times when a 256-bit key is used. A unit of repeating decryption is generally called a “stage” or “round”.

In one stage of processing, the CPU 4 reads the stored contents of the internal state array 2b (ST23), and executes an add-key (AddKey) operation (ST24). The add-key operation is to add a round key in the round key array 2a.

After the add-key operation, the CPU 4 executes byte substitution inverse transformation InvSubBytes( ) while referring to a reference table corresponding to an inverse S-box, for the stored contents (yᵢⱼ) (i, j=1, 2, 3, 4) of the internal state array 2b with 4 rows and 4 columns, and obtains 16 results of byte substitution inverse transformation s′(yᵢⱼ) (ST25), and writes these results of byte substitution inverse transformation (s′(yᵢⱼ) into the internal state array 2b of the RAM 2.

Then, the CPU 4 judges whether the stage is a final stage defined in the specifications of AES cryptography (ST26). When the stage is a final stage, the CPU 4 updates the decryption round key in the round key array 2a (ST31), and executes the add-key (AddKey) operation for the stored contents of the internal stage array 2b by using the updated round key (ST32), and outputs the obtained plaintext (ST33).

Contrarily, when the stage is judged not a final stage in the step ST26, the CPU 4 sequentially executes transformation by the first matrix Pb in the inverse mixcolumn transformation InvMixColumns( ) (ST27), and transformation by the second matrix Pa, for each j-column of the result of byte substitution inverse transformation s′(yᵢⱼ) in the internal state array 2b (ST28).

When the Transformation by the First and Second matrixes Pb and Pa are completed for all j-columns, the CPU 4 updates the results obtained (xᵢⱼ) (i, j=1, 2, 3, 4) in the internal state array 2b (ST29).

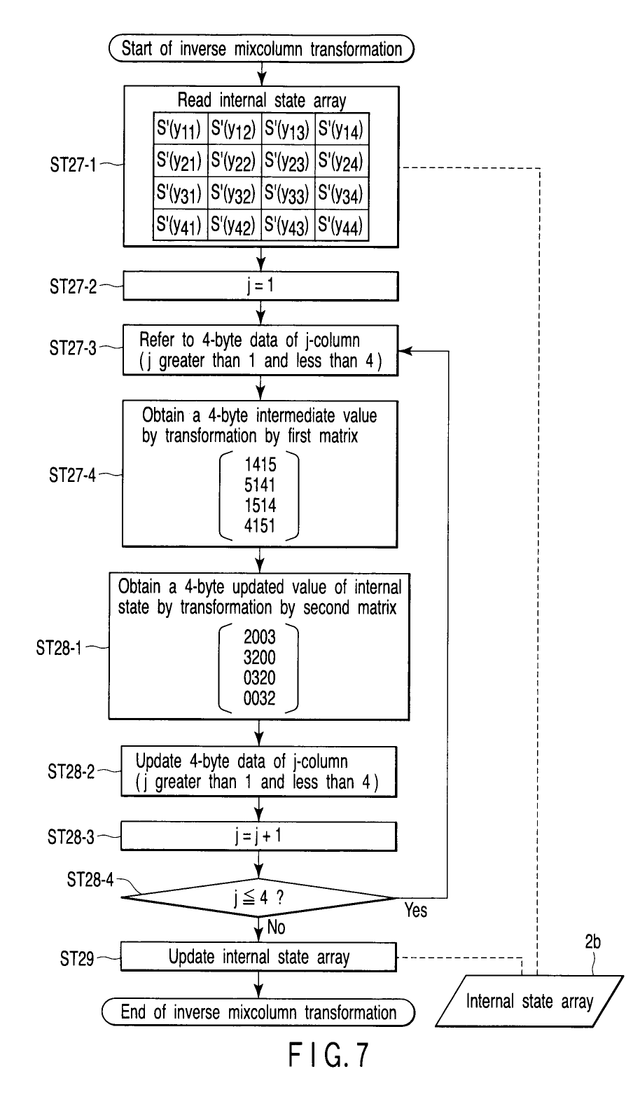

Now, an explanation will be given on the inverse mixcolumn transformation InvMixColumns( ) in the steps ST27-ST29 by using FIG. 7.

In the inverse mixcolumn transformation InvMixColumns( ), first the result of byte substitution inverse transformation s′(yᵢⱼ) stored in the internal state array 2b with 4 rows and 4 columns is read out to a temporary storage area with 4 rows and 4 columns (not shown) in the RAM 2 (ST27-1). The CPU 4 initializes a counter value j in the RAM 2 by 1 in order to execute processing for each column of the result of byte substitution inverse transformation s′(yᵢⱼ) with 4 rows and 4 columns (ST27-2).

The CPU 4 refers to the results of 4-byte byte substitution inverse transformation of the j-column s′(y₁ⱼ), . . . , s′(y₄ⱼ) indicated by the counter value j (ST27-3), executes transformation by multiplying the results of byte substitution inverse transformation s′(y₁ⱼ), . . . , s′(y₄ⱼ) by the first matrix Pb, and obtains a 4-byte intermediate value (ST27-4).

Then, the CPU 4 executes transformation by multiplying the intermediate value by the second matrix Pa, obtains the updated values x₁ⱼ, . . . , x₄ⱼ of the 4-byte internal state (ST28-1), and updates the results of byte substitution inverse transformation of the j-column in a temporary storage area s′(y₁ⱼ), . . . , s′(y₄ⱼ) to the updated values x₁ⱼ, . . . , x₄ⱼ (ST28-2).

Then, the CPU 4 adds 1 to the counter value j (ST28-3), judges whether the counter value j is lower than 4 (ST28-4), and when the counter value j is lower than 4, returns to the step ST27-3 and repeats the processing.

Contrarily, when the counter value j is judged higher than 4 in the step ST28-4, this means that the transformation by the first and second matrixes Pb and Pa is completed for all j-columns in the 1st to 4th columns.

Therefore, the CPU 4 updates the internal state array 2b by the updated value with 4 rows and 4 columns (xᵢⱼ) in the temporary storage area (ST29), and terminates the inverse mixcolumn transformation InvMixcolumns( ) shown in FIG. 7.

Thereafter, as shown in FIG. 6, the CPU 4 updates a decryption round key in the round key array 2a (ST30), as described above, and repeats the processing from the step ST23, as an operation in the next stage.

(Evaluation of Inverse Mixcolumn Transformation)

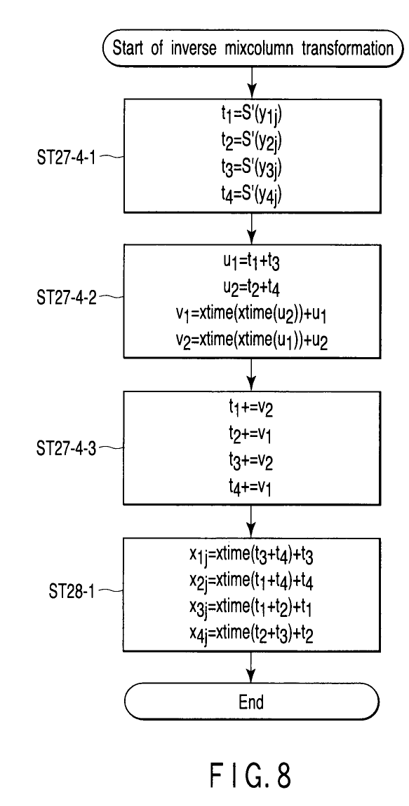

The above inverse mixcolumn transformation InvMixColumns( ) will be evaluated hereinafter. Specifically, a memory capacity necessary for calculation, complexity of calculation, and the number of calculations are summed up from the procedure of the calculation shown in FIG. 7 based on the equation (6). When the x-times calculations described in a matrix are written as xtime( ), the calculation is as shown in FIG. 8.

Namely, the CPU 4 assumes the results of byte substitution inverse transformation of the j-column s′(y₁ⱼ), . . . , s′(y₄ⱼ) referred to in the step ST27-3 to be input data t₁-t₄, and obtains the result of multiplication still in progress v₁ and v₂ by multiplying the input data t₁-t₄ by the first matrix Pb. When multiplying the input data by the first matrix Pb, the CPU executes multiplications of the coefficients {4} and {5} in the first matrix Pb by two times multiplication of the coefficient {2} and addition. In this time, the CPU 4 refers to a reference table (calculation table data) by four times.

Further, the CPU 4 obtains the intermediate values t₁-t₄ by adding the input data t₁-t₄ to the result of multiplication still in progress v₁ and v₂ (ST27-4-3). The intermediate values t₁-t₄ mean the results of multiplication of the input data t₁-t₄ and first matrix Pb.

Then, the CPU 4 calculates the updated values x₁ⱼ-x₄ⱼ of the internal state by executing multiplication of the intermediate values t₁-t₄ obtained in the step ST27-4 and second matrix Pa (ST28-1). When multiplying by the second matrix Pa, the CPU executes multiplications of the coefficients {2} and {3} in the second matrix Pa by one multiplication of the coefficient {2} and addition. In this time, the CPU 4 refers to a reference table (calculation table data) by four times.

The updated values x₁ⱼ-x₄ⱼ of the internal stage obtained in the step ST28-1 mean the results of inverse mixcolumn transformation P′ for the results of byte substitution inverse transformation s′(y₁ⱼ), . . . , s′(y₄ⱼ).

As the calculation is an operation on the Galois field, the addition + in FIG. 8 is XOR operation.

Therefore, among the values in the internal state array 2b, 4 bytes of one column are calculated. As the internal state array consists of four columns, the results of multiplication (xᵢⱼ) of the 2^{nd} column (j=2), 3^{rd} column (j=3) and 4^{th} column (j=4) are calculated based on the flowchart of FIG. 7.

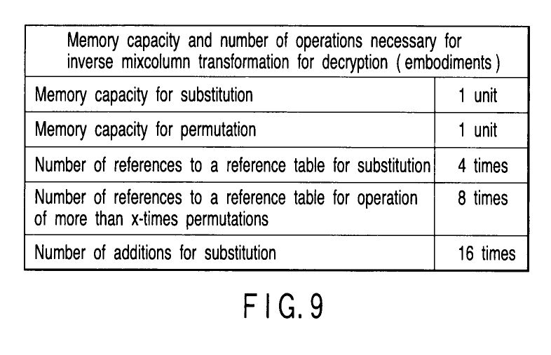

In this case, a memory capacity, the number of references to a reference table and the number of additions, such as, a memory capacity necessary for 1-unit substitution (a memory capacity of a substitution reference table [S-box]), a memory capacity necessary for 1-unit permutation (a memory capacity of a permutation reference table (results of more than x-times advance calculations), references to a reference table for 4 substitutions (the number of “s( )”), references to a reference table for more than x-times operations of 8 permutations (the number of “xtime( )”), and additions of 16 substitutions (the number of “+”), are required for each line, as shown in FIG. 9.

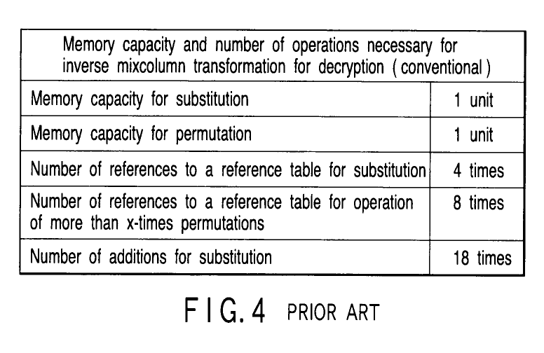

The number of references to a reference table is decreased to 8 in this embodiment, compared with 16 in the equation (3) that implements decryption of AES cryptography without modifying. The number of additions is decreased to 16 in this embodiment, compared with 18 in the conventional efficient mounting method of Paulo Barreto (FIG. 4). Namely, two times are decreased for operation of each line.

This calculation procedure refers to a reference table for a permutation memory corresponding to x-times calculations corresponding to the matrix coefficient {2}. Calculation is also possible by combining XOR of shift and constant.

As described above, according to this embodiment, when a matrix operation is executed by the products of the first and second matrixes Pb and Pa based on the specifications of the inverse mixcolumn transformation InvMixColumns( ) of AES decryption, 16 coefficients pb₁₁, . . . , pb₄₄ of the first matrix Pb consists of {1}, {4} and {5} only, and 16 coefficients pa₁₁, . . . , pa₄₄ of the second matrix Pa consists of {0}, {2} and {3} only. Therefore, as seen from the conventional example of FIG. 4 and the embodiments of the invention shown in FIG. 9, though the necessary memory capacity is the same, the number of additions can be decreased by two. Namely, in this embodiment, as the necessary memory capacity is controlled by a matrix operation and the number of operations is decreased by optimizing the coefficients in a matrix, the number of operations can be decreased while preventing increase in the necessary memory capacity. Therefore, decryption of AES cryptography can be executed in the environment not enduring sufficient memory capacity. In other words, according to this embodiment, it is possible to provide a mounting method that is highest in speed and less in the number of reading a memory and the number of operations when the memory capacity is small.

Further, this embodiment can be applied to a device that executes decryption of AES cryptography, for example, a decryption module or an IC card having an encryption/decryption module, or other cryptographic devices. By using the configuration of this embodiment, it is possible to provide a device or an apparatus having a decryption function of AES cryptography, in a computer that is strictly limited in the capacity of memory for reading/writing an IC card or a read-only memory.

This embodiment provides the similar effect even if the AES decryption apparatus 10 adopts an optional arithmetic unit whose basic unit of operation is 8 or 16 bits, such as an IC card and controller.

### Embodiment 2

An AES decryption apparatus according to a second embodiment of the invention will be explained by referring to FIG. 5. This embodiment is a modification of the first embodiment, which is configured to execute an arithmetic expression of inverse mixcolumn transformation by the following equation, instead of the equation (6).

$$[ \begin{matrix}{x}_{1 j} \\ {x}_{2 j} \\ {x}_{3 j} \\ {x}_{4 j}\end{matrix} ] = [ \begin{matrix}0 & 2 & 3 & 0 \\ 2 & 3 & 0 & 0 \\ 3 & 0 & 0 & 2 \\ 0 & 0 & 2 & 3\end{matrix} ] [ \begin{matrix}5 & 1 & 4 & 1 \\ 1 & 4 & 1 & 5 \\ 4 & 1 & 5 & 1 \\ 1 & 5 & 1 & 4\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ] \qquad ( 7 )$$

In the first matrix Pb′ of the equation (7), the first line (1415) and second line (5141) of the first matrix Pb are replaced, and the third line (1514) and fourth line (4151) of the first matrix Pb are replaced.

In the second matrix Pa′ of the equation (7), the first line (2300) and second line (0230) of the second matrix Pa, and the third line (0023) and fourth line (3002) of the second matrix Pa are replaced.

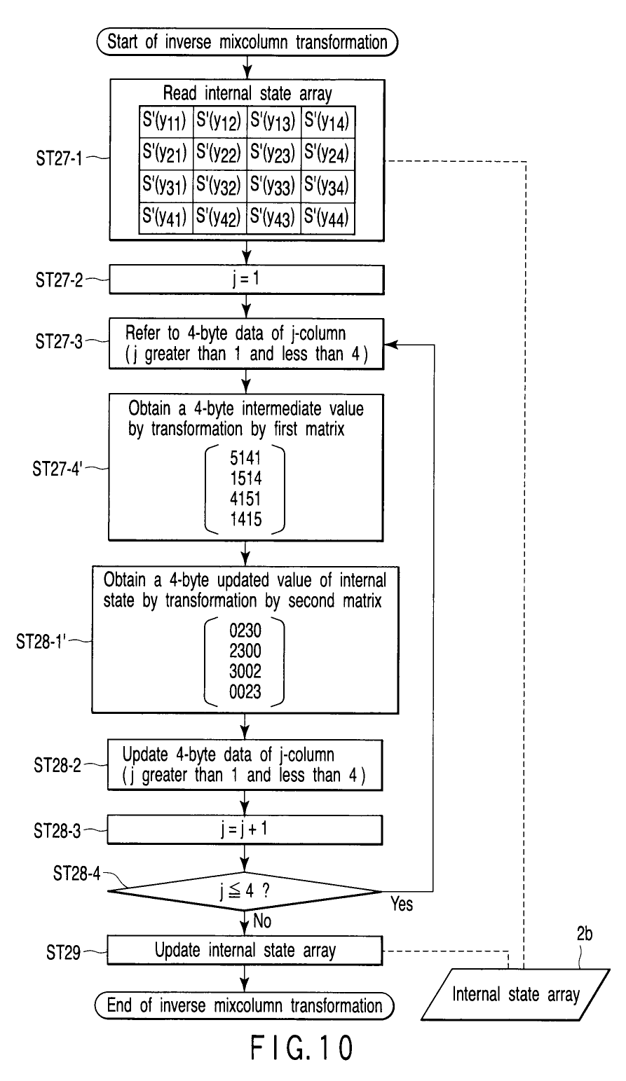

With the above configuration, the AES decryption apparatus 10 can execute decryption of AES cryptography as described herein as shown in FIG. 6 and FIG. 10, except that the order of the coefficient pbᵢⱼ in the first matrix Pb′ and the order of the coefficient paᵢⱼ in the second matrix Pa′ are different from the first embodiment (refer to ST27-4′ and ST28-1′ in FIG. 10).

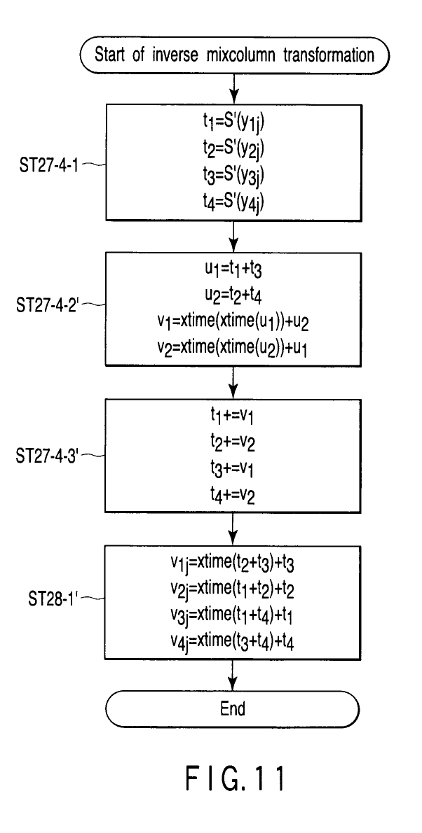

The procedure of calculating the equation (7) is as shown in FIG. 11. As the calculation is an operation on a Galois field, the addition + in FIG. 11 is an XOR operation, as described hereinbefore.

In this case, a memory capacity, the number of references to a reference table and number of additions, such as, a memory capacity necessary for 1-unit substitution (a memory capacity of a substitution reference table [S-box]), a memory capacity necessary for 1-unit permutation (a memory capacity of a permutation reference table [results of more than x-times advance calculations]), references to a reference table for 4 substitutions (the number of “s( )”), references to a reference table for more than x-times operations of 8 permutations (the number of “xtime( )”), and additions of 16 substitutions (the number of “+”), are required for each line, as in FIG. 9.

As described above, according to this embodiment, it is possible to operate the same as the first embodiment and to provide the same effect. Specifically, this embodiment can realize decryption of AES cryptography by the same manpower of calculation as in the first embodiment. Because, the equations (7) and (6) seem different, but the equation (7) can be solved by replacing a row or column, which is called basic deformation of a matrix.

According to basic deformation of a matrix, not limited to the equation (7) of this embodiment, multiplication can be executed by appropriately using a first matrix Pb′ that is obtained by performing one or both of row replacement and column replacement in the first matrix Pb, instead of the first matrix Pb, and a second matrix Pa′ that is obtained by performing column replacement corresponding to the row replacement in the first matrix Pb and row replacement corresponding the column replacement in the first matrix Pb, instead of the second matrix Pa.

In other words, multiplication can be executed by using a first matrix Pb′ that is obtained by replacing one or both of “rows i” and “columns j” in the first matrix Pb, instead of the first matrix Pb, and a second matrix Pa′ that is obtained by replacing one or both of “columns i” and “rows j” in the second matrix Pa corresponding to the replacement in the first matrix Pb, instead of the second matrix Pa.

When basic deformation of a matrix that performs replacement of row or column is applied to the product of two matrixes, the operation is as follows. In the basic deformation of a matrix, when rows i in the first matrix Pb are replaced, columns i in the second matrix Pa are to be replaced corresponding to the replacement of rows. Namely, when rows i are replaced in one matrix, columns i are to be replaced in the other matrix. For example, when first and fifth rows of the first matrix Pb are replaced, first and fourth columns of the second matrix Pa are to be replaced, corresponding to the replacement of rows.

Contrarily, when columns j are replaced in the first matrix Pb, rows j are to be replaced in the second matrix Pa. Namely, when columns j and j′ are replaced in one matrix, columns j and j′ are replaced in the other matrix. For example, when first and fifth columns of the first matrix Pb are replaced, first and fourth rows of the second matrix Pa are to be replaced.

In basic deformation of a matrix, replacement of row and column may be performed several times.

The technique described above for the embodiment can be stored as a program to be executed by a computer in memory mediums including magnetic disks (Floppy™ disks, hard disks, etc.), optical disks (CD-ROMs, DVDs, etc.), magneto-optical disks (MOs) and semiconductor memories for distribution.

Memory mediums that can be used for the purpose of the present invention are not limited to those listed above and memory mediums of any type can also be used for the purpose of the present invention so long as they are computer-readable ones.

Additionally, the OS (operating system) operating on a computer according to the instructions of a program installed in the computer from a memory medium, data base management software and/or middleware such as network software may take part in each of the processes for realizing the above embodiment.

Still additionally, memory mediums that can be used for the purpose of the present invention are not limited to those independent from computers but include memory mediums adapted to download a program transmitted by LANs and/or the Internet and permanently or temporarily store it.

It is not necessary that a single memory medium is used with the above described embodiment. In other words, a plurality of memory mediums may be used with the above-described embodiment to execute any of the above described various processes. Such memory mediums may have any configuration.

For the purpose of the present invention, a computer executes various processes according to one or more than one programs stored in the memory medium or mediums as described above for the preferred embodiment. More specifically, the computer may be a stand alone computer or a system realized by connecting a plurality of computers by way of a network.

For the purpose of the present invention, computers include not only personal computers but also processors and microcomputers contained in information processing apparatus. In other words, computers generally refer to apparatus and appliances that can realize the functional features of the present invention by means of a computer program.

The present invention is by no means limited to the above described embodiment, which may be modified in various different ways without departing from the spirit and scope of the invention. Additionally, any of the components of the above described embodiment may be combined differently in various appropriate ways for the purpose of the present invention. For example, some of the components of the above described embodiment may be omitted. Alternatively, components of different embodiments may be combined appropriately in various different ways for the purpose of the present invention.

What is claimed is:

1. An AES decryption apparatus of AES cryptography including byte substitution inverse transformation InvSubBytes( ) and inverse mixcolumn transformation InvMixColumns( ), comprising:
an inverse S-box storage device which is used for the byte substitution inverse transformation InvSubBytes( ), and stores S-box information that previously associates row and column data of half bits of substitution object data with a result of byte substitution inverse transformation s′( );
a byte substitution inverse transformation device configured to execute the byte substitution inverse transformation InvSubBytes( ), to obtain a result of byte substitution inverse transformation s′(yᵢⱼ) while referring to the inverse S-box information, based on input data yᵢⱼ (i, j=1, 2, 3, 4) with 4 rows and 4 columns as the substitution object data;
a byte substitution inverse transformation result storage device which stores the result of byte substitution inverse transformation s′(yᵢⱼ) obtained by the byte substitution inverse transformation device;
an inverse mixcolumn transformation device configured to execute the inverse mixcolumn transformation InvMixColumns( ), to obtain results of inverse mixcolumn transformation (x₁ⱼ, x₂ⱼ, . . . x₄ⱼ), by multiplying results of byte substitution inverse transformation for each column (s′(y₁ⱼ), s′(y₂ⱼ), . . . , s′(y₄ⱼ)) by a first matrix Pb=(pbᵢⱼ) (i, j=1, 2, 3, 4) and second matrix Pa=(paᵢⱼ) (i, j=1, 2, 3, 4), based on the result of byte substitution inverse transformation s′(yᵢⱼ) in the byte substitution inverse transformation result storage device, as indicated by the equation
$$[ \begin{matrix}{x}_{1 j} \\ {x}_{2 j} \\ {x}_{3 j} \\ {x}_{4 j}\end{matrix} ] = [ \begin{matrix}{pa}_{11} & {pa}_{12} & … & {pa}_{14} \\ {pa}_{21} & {pa}_{22} & … & {pa}_{24} \\ {pa}_{31} & {pa}_{32} & … & {pa}_{34} \\ {pa}_{41} & {pa}_{42} & … & {pa}_{44}\end{matrix} ] [ \begin{matrix}{pb}_{11} & {pb}_{12} & … & {pb}_{14} \\ {pb}_{21} & {pb}_{22} & … & {pb}_{24} \\ {pb}_{31} & {pb}_{32} & … & {pb}_{34} \\ {pb}_{41} & {pb}_{42} & … & {pb}_{44}\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ]$$
wherein 16 coefficients pb₁₁, . . . , pb₄₄ of the first matrix Pb consist of {1}, {4} and {5} only, and
16 coefficients pa₁₁, . . . , pa₄₄ of the second matrix Pa consist of {0}, {2} and {3} only.

2. The AES decryption apparatus according to claim 1, wherein the first matrix Pb is
$$Pb = [ \begin{matrix}1 & 4 & 1 & 5 \\ 5 & 1 & 4 & 1 \\ 1 & 5 & 1 & 4 \\ 4 & 1 & 5 & 1\end{matrix} ]$$
and the second matrix Ps is
$$P a = [ \begin{matrix}2 & 0 & 0 & 3 \\ 3 & 2 & 0 & 0 \\ 0 & 3 & 2 & 0 \\ 0 & 0 & 3 & 2\end{matrix} ]$$

3. The AES decryption apparatus according to claim 2, wherein the inverse mixcolumn transformation device executes the multiplication, by using a first matrix Pb′ obtained by performing one or both of row replacement or column replacement in the first column Pb, and a second column Pa′ which is obtained by performing column replacement corresponding to row replacement in the first matrix Pb, and row replacement corresponding to the column replacement in the first matrix Pb, as the matrixes Pb and Pa.

4. The AES decryption apparatus according to claim 3, wherein when performing the multiplication, the inverse mixcolumn transformation device executes multiplication of coefficient {4} and multiplication of coefficient {5} in the first matrix by two multiplications of coefficient {2} and addition, and executes multiplication of coefficient {2} and multiplication of coefficient {3} in the second matrix by a multiplication of coefficient {2} and addition.

5. The AES decryption apparatus according to claim 4, further comprising a multiplication table storage device storing multiplication table data indicating the result of multiplication of the coefficient {2},
wherein the inverse mixcolumn transformation device executes multiplication of the coefficient {2} while referring to the multiplication table data.

6. The AES decryption apparatus according to claim 1, wherein when performing the multiplication, the inverse mixcolumn transformation device executes multiplication of coefficient {4} and multiplication of coefficient {5} in the first matrix by two multiplications of coefficient {2} and addition, and executes multiplication of coefficient {2} and multiplication of coefficient {3} in the second matrix by a multiplication of coefficient {2} and addition.

7. The AES decryption apparatus according to claim 6, further comprising a multiplication table storage device storing multiplication table data indicating the result of multiplication of the coefficient {2},
wherein the inverse mixcolumn transformation device executes multiplication of the coefficient {2} while referring to the multiplication table data.

8. The AES decryption apparatus according to claim 2, wherein when performing the multiplication, the inverse mixcolumn transformation device executes multiplication of coefficient {4} and multiplication of coefficient {5} in the first matrix by two multiplications of coefficient {2} and addition, and executes multiplication of coefficient {2} and multiplication of coefficient {3} in the second matrix by a multiplication of coefficient {2} and addition.

9. The AES decryption apparatus according to claim 8, further comprising a multiplication table storage device storing multiplication table data indicating the result of multiplication of the coefficient {2},
wherein the inverse mixcolumn transformation device executes multiplication of the coefficient {2} while referring to the multiplication table data.

10. A program stored in a storage medium readable from a computer used as a computer of an AES decryption apparatus of AES cryptography including byte substitution inverse transformation InvSubBytes( ) and inverse mixcolumn transformation InvMixColumns( ) comprising:
a first program code which causes a computer to sequentially write S-box information, which is used for the byte substitution inverse transformation InvSubBytes( ), and previously associates row and column data of half bits of substitution object data with a result of byte substitution inverse transformation, s′( ), into a memory of the computer;
a second program code which causes a computer to sequentially execute the byte substitution inverse transformation, and obtain a result of byte substitution inverse transformation s′(yᵢⱼ) by executing the byte substitution inverse transformation InvSubBytes( ) while referring to the inverse S-box information, based on input data yᵢⱼ (i, j=1, 2, 3, 4) with 4 rows and 4 columns as the substitution object data;
a third program code which causes a computer to sequentially write the result of byte substitution inverse transformation s′(yᵢⱼ) obtained by the byte substitution inverse transformation;
a fourth program code which causes a computer to sequentially execute the inverse mixcolumn transformation to obtain results of inverse mixcolumn transformation (x₁ⱼ, x₂ⱼ, . . . , x₄ⱼ) by executing the inverse mixcolumn transformation InvMixColumns( ), by multiplying results of byte substitution inverse transformation for each column (s′(y₁ⱼ), s′(y₂ⱼ), . . . , s′(y₄ⱼ)) by a first matrix Pb=(pbᵢⱼ) (i, j=1, 2, 3, 4) and second matrix Pa=(paᵢⱼ) (i, j=1, 2, 3, 4), based on the result of byte substitution inverse transformation s′(yᵢⱼ) in the memory, as indicated by the equation
$$[ \begin{matrix}{x}_{1 j} \\ {x}_{2 j} \\ {x}_{3 j} \\ {x}_{4 j}\end{matrix} ] = [ \begin{matrix}{pa}_{11} & {pa}_{12} & … & {pa}_{14} \\ {pa}_{21} & {pa}_{22} & … & {pa}_{24} \\ {pa}_{31} & {pa}_{32} & … & {pa}_{34} \\ {pa}_{41} & {pa}_{42} & … & {pa}_{44}\end{matrix} ] [ \begin{matrix}{pb}_{11} & {pb}_{12} & … & {pb}_{14} \\ {pb}_{21} & {pb}_{22} & … & {pb}_{24} \\ {pb}_{31} & {pb}_{32} & … & {pb}_{34} \\ {pb}_{41} & {pb}_{42} & … & {pb}_{44}\end{matrix} ] [ \begin{matrix}{s}^{′} ( {y}_{1 j} ) \\ {s}^{′} ( {y}_{2 j} ) \\ {s}^{′} ( {y}_{3 j} ) \\ {s}^{′} ( {y}_{4 j} )\end{matrix} ]$$
wherein 16 coefficients pb₁₁, . . . , pb₄₄ of the first matrix Pb consist of {1}, {4} and {5} only, and
16 coefficients pa₁₁, . . . , pa₄₄ of the second matrix Pa consist of {0}, {2} and {3} only.

11. The AES decryption apparatus according to claim 10, wherein the first matrix Pb is
$$Pb = [ \begin{matrix}1 & 4 & 1 & 5 \\ 5 & 1 & 4 & 1 \\ 1 & 5 & 1 & 4 \\ 4 & 1 & 5 & 1\end{matrix} ]$$
and the second matrix Ps is
$$P a = [ \begin{matrix}2 & 0 & 0 & 3 \\ 3 & 2 & 0 & 0 \\ 0 & 3 & 2 & 0 \\ 0 & 0 & 3 & 2\end{matrix} ]$$

12. The program according to claim 11, wherein the inverse mixcolumn transformation is a processing to execute the multiplication, by using a first matrix Pb′ obtained by performing one or both of row replacement or column replacement in the first column Pb, and a second column Pa′ which is obtained by performing column replacement corresponding to the row replacement in the first matrix Pb, and row replacement corresponding to the column replacement in the first matrix Pb, as the matrixes Pb and Pa.

13. The program according to claim 12, wherein when performing the multiplication, the inverse mixcolumn transformation is a processing to execute multiplication of coefficient {4} and multiplication of coefficient {5} in the first matrix by two multiplications and addition, and executes multiplication of coefficient {2} and multiplication of coefficient {3} in the second matrix by a multiplication of coefficient {2} and addition.

14. The program according to claim 13, further comprising a fifth program code which causes a computer to previously write multiplication table data indicating the result of multiplication of the coefficient {2} into a memory,
wherein the inverse mixcolumn transformation is a processing to execute multiplication of the coefficient {2} while referring to the multiplication table data.

15. The program according to claim 10, wherein when performing the multiplication, the inverse mixcolumn transformation is a processing to execute multiplication of coefficient {4} and multiplication of coefficient {5} in the first matrix by two multiplications and addition, and executes multiplication of coefficient {2} and multiplication of coefficient {3} in the second matrix by a multiplication of coefficient {2} and addition.

16. The program according to claim 15, further comprising a fifth program code which causes a computer to previously write multiplication table data indicating the result of multiplication of the coefficient {2} into a memory,
wherein the inverse mixcolumn transformation is a processing to execute multiplication of the coefficient {2} while referring to the multiplication table data.

17. The program according to claim 11, wherein when performing the multiplication, the inverse mixcolumn transformation is a processing to execute multiplication of coefficient {4} and multiplication of coefficient {5} in the first matrix by two multiplications and addition, and executes multiplication of coefficient {2} and multiplication of coefficient {3} in the second matrix by a multiplication of coefficient {2} and addition.

18. The program according to claim 17, further comprising a fifth program code which causes a computer to previously write multiplication table data indicating the result of multiplication of the coefficient {2} into a memory,
wherein the inverse mixcolumn transformation is a processing to execute multiplication of the coefficient {2} while referring to the multiplication table data.
